(19) United States
(12) Patent Application Publication
(10) Pub. No.: US 2018/0128122 A1
(43) Pub. Date: May 10, 2018

(54) APPARATUS AND METHOD FOR PROVIDING FLUID TO A BEARING DAMPER

(71) Applicant: UNITED TECHNOLOGIES CORPORATION, Farmington, CT (US)

(72) Inventors: Thomas Bruce Avis, Manchester, CT (US); Michael Dreher, Prospect, CT (US); Erik R. Granstrand, West Hartford, CT (US)

(21) Appl. No.: 15/344,157

(22) Filed: Nov. 4, 2016

(51) Int. Cl. F01D 25/16; F01D 5/02; F01D 25/18; F01D 25/32; F01D 25/24

(52) U.S. Cl. CPC F01D 25/164; F01D 5/02; F01D 25/18; F05D 2260/231; F01D 25/24; F05D 2230/60; F01D 25/32

(57) ABSTRACT

A lubricant supply system for a bearing damper in an engine bearing compartment of a gas turbine engine, the bearing compartment rotatably supporting an engine component and including a drain system for purging excess lubricant, including a first interface, a second interface, a drain conduit fluidly coupled to the first interface and extending from the first interface to the second interface, the drain conduit receiving fluid, including excess lubricant and lubricant purging air, from the first interface, a supply conduit located within the drain conduit, extending between the interfaces the supply conduit providing lubricant to the bearing damper and fluid in the drain conduit is capable of insulting fluid in the supply conduit from heat transferred through the interfaces.

### BACKGROUND

This disclosure relates to gas turbine engines, and more particularly to an apparatus and method for providing fluid to a bearing damper of the gas turbine engine.

Gas turbine engines are used in numerous applications, one of which is for providing thrust to an aircraft. When a gas turbine engine of an aircraft has been shut off for example, after an aircraft has landed at an airport, the engine is hot and due to heat rise, the upper portions of the engine will be hotter than lower portions of the engine. When this occurs thermal expansion may cause deflection of components of the engine which may result in a “bowed rotor” condition. When starting an engine with a “bowed rotor” condition, a resulting significant rotational imbalance can excite fundamental modes of components of the engine. This in turn produces excessive deflections of the engine rotor, while bowing of the engine case can result in a reduction in normal build clearances and thus results in a potential for rubbing between the rotating turbomachinery and the closed-down case structure. The rub condition can result in a hung start or a performance loss in the turbomachinery.

Accordingly, it is desirable to provide a method and/or apparatus for providing fluid to a bearing damper of a gas turbine engine.

### BRIEF DESCRIPTION

Disclosed is a lubricant supply system for a bearing damper in an engine bearing compartment of a gas turbine engine, the bearing compartment rotatably supporting an engine component and including a drain system for purging excess lubricant, comprising: a first interface; a second interface; a drain conduit fluidly coupled to the first interface and extending from the first interface to the second interface; the drain conduit receiving fluid including excess lubricant and lubricant purging air from the first interface; a supply conduit located within the drain conduit extending between the interfaces; the supply conduit providing lubricant to the bearing damper; and fluid in the drain conduit is capable of insulting fluid in the supply conduit from heat transferred through the interfaces.

In addition to one or more of the features described above, or as an alternative, further embodiments may include that: the component is a turbine section, which includes a high pressure turbine, the bearing compartment is located in the turbine section, and the drain system is a scupper drain system; the first interface connects with the engine bearing compartment; the second interface connects with a turbine intermediate case; the drain conduit is a scupper drain conduit; and the supply conduit is a bearing damper supply conduit.

In addition to one or more of the features described above, or as an alternative, further embodiments may include a joint where the second interface connects with the drain conduit, the joint comprises a piloted o-ring.

In addition to one or more of the features described above, or as an alternative, further embodiments may include that the drain conduit has a fluid inlet at the first interface, which includes a plurality of drain openings.

Also disclosed is a gas turbine engine comprising: a bearing compartment rotatably supporting an engine component and including a bearing damper and a drain system for purging excess lubricant; a lubricant supply system for providing lubricant to the bearing damper, comprising: a first interface; a second interface; a drain conduit fluidly coupled to the first interface and extending from the first interface to the second interface; the drain conduit receiving fluid, including excess lubricant and lubricant purging air, from the first interface; a supply conduit located within the drain conduit, the supply conduit providing lubricant to the bearing damper; and fluid in the drain conduit is capable of insulting fluid in the supply conduit from heat transferred through the interfaces.

In addition to one or more of the features described above, or as an alternative, further embodiments may include that: the component is a turbine section, which includes a high pressure turbine, and the bearing compartment is located in the turbine section, and the drain system is a scupper drain system; the first interface connects with the engine bearing compartment; the second interface connects with a turbine intermediate case; the drain conduit is a scupper drain conduit; and the supply conduit is a bearing damper supply conduit.

In addition to one or more of the features described above, or as an alternative, further embodiments may include a joint, where the second interface connects with the drain conduit, the joint comprises a piloted o-ring.

In addition to one or more of the features described above, or as an alternative, further embodiments may include that the drain conduit has a fluid inlet at the first interface, which includes a plurality of drain openings.

Further disclosed is a method of supplying lubricant to a bearing damper of bearing compartment of a gas turbine engine, comprising: fluidly coupling a drain conduit to the bearing compartment, wherein the drain conduit receives fluid, including excess bearing lubricant and lubricant purging air, flowing in a first direction, away from the bearing compartment; fluidly coupling a supply conduit to the bearing damper, wherein the supply conduit is located within the drain conduit and supplies lubricant in a second direction to the bearing damper, the second direction flowing toward the bearing compartment; and insulating the lubricant in the supply conduit from heat transferred through one or more interfaces connecting the supply conduit to the engine with the engine buffer air that flows through an insulating cavity defined between an interior surface of the drain conduit and an exterior surface of the supply conduit.

In addition to one or more of the features described above, or as an alternative, further embodiments may include that the drain conduit is connected at a joint to a turbine intermediate case interface with a piloted o-ring.

### BRIEF DESCRIPTION OF THE DRAWINGS

The following descriptions should not be considered limiting in any way. With reference to the accompanying drawings, like elements are numbered alike:

FIG. 1 is cross section of a disclosed gas turbine engine;

FIG. 2 illustrates a first section of a turbine bearing damper supply according to an embodiment; and

FIG. 3 illustrates a second section of a turbine bearing damper supply according to an embodiment.

### DETAILED DESCRIPTION

A detailed description of one or more embodiments of the disclosed apparatus and method are presented herein by way of exemplification and not limitation with reference to the Figures.

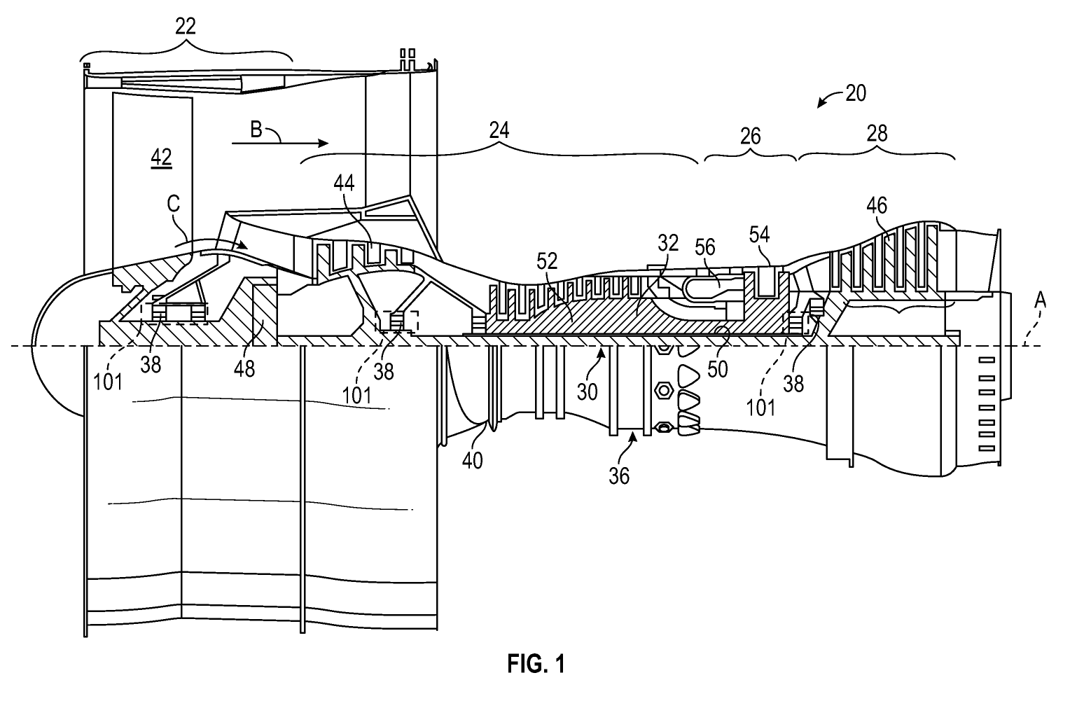

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. Alternative engines might include an augmentor section (not shown) among other systems or features. The fan section 22 drives air along a bypass flow path B in a bypass duct, while the compressor section 24 drives air along a core flow path C for compression and communication into the combustor section 26 then expansion through the turbine section 28. Although depicted as a two-spool turbofan gas turbine engine in the disclosed non-limiting embodiment, it should be understood that the concepts described herein are not limited to use with two-spool turbofans as the teachings may be applied to other types of turbine engines including three-spool architectures.

The exemplary engine 20 generally includes a low speed spool 30 and a high speed spool 32 mounted for rotation about an engine central longitudinal axis A relative to an engine static structure 36 via several bearing compartments 38. It should be understood that various bearing compartments 38 at various locations may alternatively or additionally be provided, and the location of bearing compartments 38 may be varied as appropriate to the application.

The low speed spool 30 generally includes an inner shaft 40 that interconnects a fan 42, a low pressure compressor 44 and a low pressure turbine 46. The inner shaft 40 is connected to the fan 42 through a speed change mechanism, which in exemplary gas turbine engine 20 is illustrated as a geared architecture 48 to drive the fan 42 at a lower speed than the low speed spool 30. The high speed spool 32 includes an outer shaft 50 that interconnects a high pressure compressor 52 and high pressure turbine 54. A combustor 56 is arranged in exemplary gas turbine 20 between the high pressure compressor 52 and the high pressure turbine 54. An engine static structure 36 is arranged generally between the high pressure turbine 54 and the low pressure turbine 46. The engine static structure 36 further supports bearing compartments 38 in the turbine section 28. The inner shaft 40 and the outer shaft 50 are concentric and rotate via bearing compartments 38 about the engine central longitudinal axis A which is collinear with their longitudinal axes.

The core airflow is compressed by the low pressure compressor 44 then the high pressure compressor 52, mixed and burned with fuel in the combustor 56, then expanded over the high pressure turbine 54 and low pressure turbine 46. The turbines 46, 54 rotationally drive the respective low speed spool 30 and high speed spool 32 in response to the expansion. It will be appreciated that each of the positions of the fan section 22, compressor section 24, combustor section 26, turbine section 28, and fan drive gear system 48 may be varied. For example, gear system 48 may be located aft of combustor section 26 or even aft of turbine section 28, and fan section 22 may be positioned forward or aft of the location of gear system 48.

The engine 20 in one example is a high-bypass geared aircraft engine. In a further example, the engine 20 bypass ratio is greater than about six (6), with an example embodiment being greater than about ten (10), the geared architecture 48 is an epicyclic gear train, such as a planetary gear system or other gear system, with a gear reduction ratio of greater than about 2.3 and the low pressure turbine 46 has a pressure ratio that is greater than about five. In one disclosed embodiment, the engine 20 bypass ratio is greater than about ten (10:1), the fan diameter is significantly larger than that of the low pressure compressor 44, and the low pressure turbine 46 has a pressure ratio that is greater than about five (5:1). Low pressure turbine 46 pressure ratio is pressure measured prior to inlet of low pressure turbine 46 as related to the pressure at the outlet of the low pressure turbine 46 prior to an exhaust nozzle. The geared architecture 48 may be an epicycle gear train, such as a planetary gear system or other gear system, with a gear reduction ratio of greater than about 2.3:1. It should be understood, however, that the above parameters are only exemplary of one embodiment of a geared architecture engine and that the present disclosure is applicable to other gas turbine engines including direct drive turbofans.

A significant amount of thrust is provided by the bypass flow B due to the high bypass ratio. The fan section 22 of the engine 20 is designed for a particular flight condition—typically cruise at about 0.8 Mach and about 35,000 feet (10,688 meters). The flight condition of 0.8 Mach and 35,000 ft (10,688 meters), with the engine at its best fuel consumption—also known as “bucket cruise Thrust Specific Fuel Consumption (‘TSFC’)”—is the industry standard parameter of lbm of fuel being burned divided by lbf of thrust the engine produces at that minimum point. “Low fan pressure ratio” is the pressure ratio across the fan blade alone, without a Fan Exit Guide Vane (“FEGV”) system. The low fan pressure ratio as disclosed herein according to one non-limiting embodiment is less than about 1.45. “Low corrected fan tip speed” is the actual fan tip speed in ft/sec divided by an industry standard temperature correction of [(Tram ° R)/(518.7° R)]0.5. The “Low corrected fan tip speed” as disclosed herein according to one non-limiting embodiment is less than about 1150 ft/second (350.5 m/sec).

Various embodiments of the present disclosure are related to a damping system in a gas turbine engine. To assist in minimizing the potential and impact of a bowed rotor start response, a gas turbine engine employs one or more fluid film/squeeze-film dampers in bearing supports to provide viscous type damping and dissipation of the bowed rotor excitation energy as well as other sources of vibration. However, at low speeds where bowed rotor modes occur in the operating range, the dampers may not always be filled sufficiently with oil or fully pressurized so that the dampers may not be providing sufficient or optimal damping to counteract the bowed rotor response. Additionally, as the oil pumps are typically driven by rotation of the engine, oil pumps used to lubricate and dampen vibrations within a gas turbine engine may not provide sufficient oil pressure at startup and at low speeds.

Moreover, due to exposure to intense heat in hotter sections of the gas turbine engine, such as in the turbine section 28, and specifically, in the high pressure turbine 54, oil directed to the damper bearings for the high pressure turbine via, e.g., the turbine intermediate case, may heat up and coke.

Specifically, the bearing damper 101 for the high pressure turbine 54 is fed by the oil feed line that supplies oil to the rest of the bearing compartments 38. A bowed rotor in the high pressure turbine 54, caused by heat rising inside the engine 20 during heat soak after shutdown, can cause an imbalance during the next engine start. The imbalance in the high pressure turbine 54 can cause blades to contact the cases during a bowed rotor start which can then lead to loss of stall margin.

The bearing damper 101 in the high pressure turbine 54 can mitigate imbalance in the rotor. As indicated, the damper in the high pressure turbine 54 may be ineffective at start, however, due to low oil pressure, because oil pressure is driven by the engine rotor shaft which slowly spools up. Therefore, with the damper 101 in the high pressure turbine 54 failing at startup to adequately dampen out the imbalance caused by the bowed rotor, start times are purposely longer to prevent rubbing blades out.

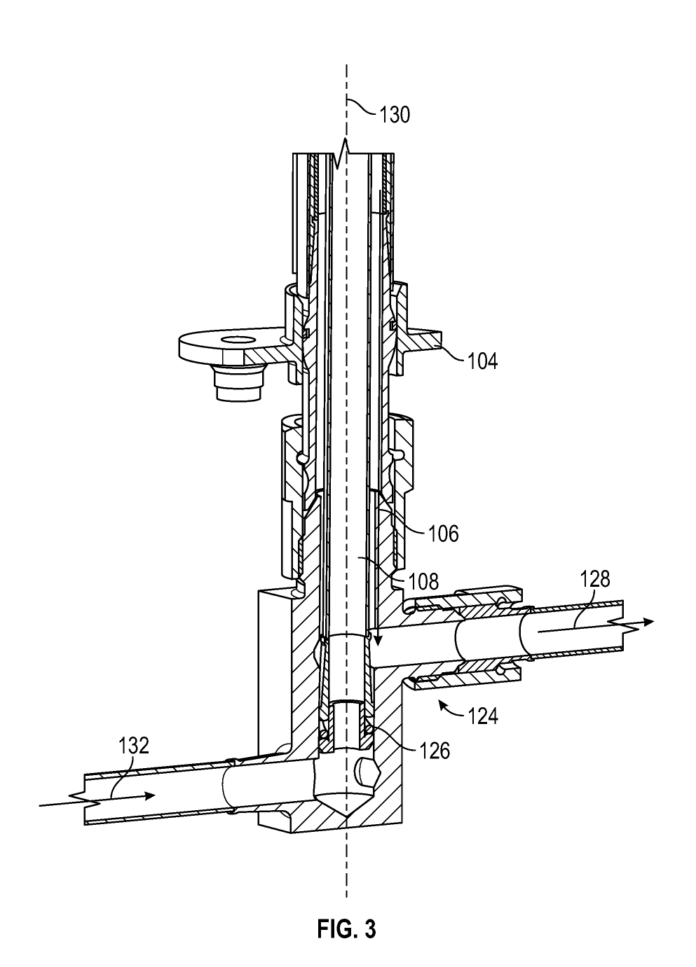

Turning now to FIGS. 1-3, a lubricant supply system 100 for a bearing damper 101 of the gas turbine engine 20 is illustrated. Non-limiting locations of bearing dampers 101 are illustrated schematically by dashed lines in FIG. 1.

The lubricant supply system 100 includes a first interface 102, a second interface 104. The interfaces 102, 104 are outside the core flow path. The interfaces 102, 104 may heat up because of connections with hotter engine components, due to heat radiating and conducting though the engine. For example, interface 104 may heat up from the turbine intermediate case in the turbine section 28.

In the illustrated embodiment, a drain conduit 106 may be fluidly coupled to the first interface 102, and extends from the first interface 102 to the second interface 104. A supply conduit 108 is located within the drain conduit 106, extending between the interfaces 102, 104. The drain conduit 106 receives excess lubricant from the first interface 102 and the supply conduit 108 provides lubricant to the bearing damper 101. An insulating cavity is defined between an interior surface of the second conduit 108 and an exterior surface of the first conduit 106.

According to an embodiment, the first interface 102 may be a bearing compartment interface, and the second interface 104 may be a turbine intermediate case interface. In addition, the drain conduit 106 may be a scupper drain conduit or an air/oil scupper overboard drain tube, and the supply conduit 108 may be a bearing damper supply conduit. The scupper drain conduit 106 receives excess oil that escapes from the bearing compartment seals. The scupper drain conduit 106 is purged by a flow of buffer air from the engine buffer systems.

The scupper drain conduit 106 is insulted and shielded from heat in the area of exposure to engine core flow. This insulation, however, does not function to insulate from heat transferred via the interfaces 102, 104.

In the disclosed system 100, the damper supply conduit 108 inside the scupper drain conduit 106 is insulated from heat transferred through the interfaces 102, 104 by air flowing inside the scupper drain conduit 106. That is, this configuration takes advantage of air passing through the insulting cavity between the outer surface of the damper supply conduit 108 and the inner surface of the scupper drain conduit 106. Since air is an excellent insulator, the relatively cool air (as compared to the temperature outside of the scupper drain conduit 106) moving through the scupper drain conduit 106 will reduce the influence of the heat transferred, e.g., radiated and conducted from the turbine intermediate case into the interface 104 and into the outer surface of the scupper drain conduit 106. By reducing the influence of the heated interfaces 102, 104 on the supply oil in the damper supply conduit 108, this will prevent the supply oil from overheating and coking.

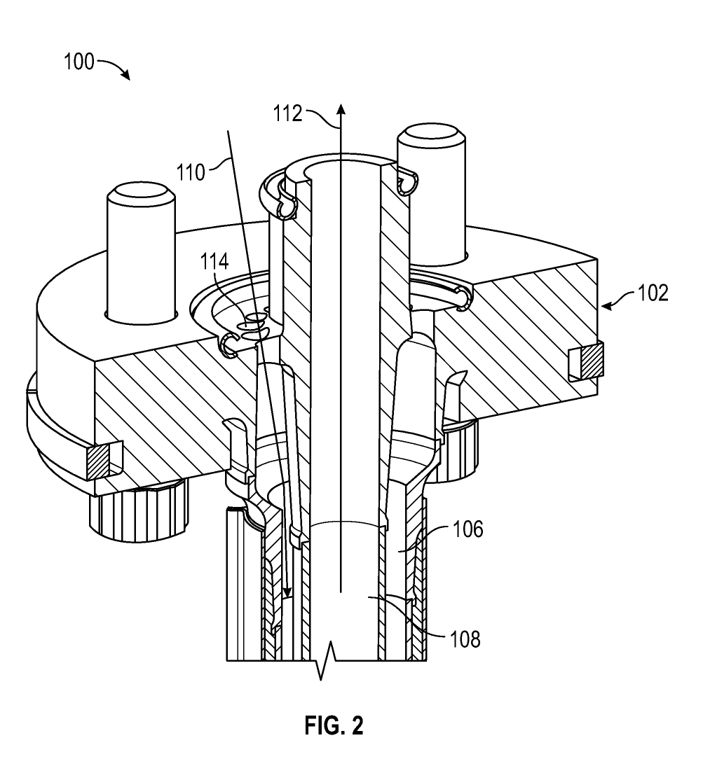

As illustrated in FIG. 2, lubricant in the scupper drain conduit 106 flows in a first direction 110, away from the first interface 102, while fluid in the damper supply conduit 108 flows in a second direction 112, opposed to the first direction 110, toward the first interface 102. Further and in one embodiment, fluid in the scupper drain conduit 106 may be air and/or oil. In addition and in one embodiment, the scupper drain conduit 106 may have a fluid inlet 114 at the first interface 102. In order to allow the fluids (e.g., buffer air, excess oil or a combination of air/oil) to flow in the first direction 110, a plurality of drain openings are located in the fluid inlet 114.

According to an embodiment, the system 100 includes a joint 124 that connects with the second interface 104 with a piloted o-ring. Utilizing a piloted o-ring joint connection on the scupper drain conduit 106 at the turbine intermediate case interface 102 enables slippage along the longitudinal axis 130 of the conduit 106. This reduces thermal stress that could occur between the colder damper oil tube and the hotter structure in the scupper tube 106 as heat is transferred from the interfaces 102, 104 to the outer surface of the scupper drain conduit 106.

In one embodiment, at the second interface 104, the drain conduit 106 disposes of fluids via an outlet conduit 128 while the supply conduit 108 receives fluids via an inlet conduit 132. In the non-limiting illustration, the inlet and outlet conduits 128, 132 extend opposing directions relative to an axis 130 between the first interface 102 and the second interface 104.

In one embodiment, the lubricant supply system 100 is used to supply lubricant to at least one bearing damper 101 of one of the plurality of bearing compartments 38 in the engine 20. In the engine 20, the bearing compartment interface 102 of the system 100 is connected with the bearing compartment 38 of the turbine section 28. The turbine intermediate case interface 104 of the system is connected with the turbine intermediate case. Further, the bearing damper 101 of the system 100 is a bearing damper 101 for the high pressure turbine 54.

Also disclosed herein is a method of supplying lubricant to the bearing damper 101 of bearing compartment 38 of the gas turbine engine 20. The method includes fluidly coupling the scupper drain conduit 106 to the bearing compartment 38. The scupper drain conduit 106 receives fluid, including excess bearing lubricant and lubricant purging air from engine buffer systems, in the first direction 110, flowing away from the bearing compartment 38. The method further includes fluidly coupling the damper supply conduit 108 to the bearing damper 101. The damper supply conduit 108 is located within the scupper drain conduit 106 and supplies lubricant in the second direction 112 to the bearing damper 101. The second direction flows toward the bearing compartment 38, e.g., opposed to the first direction 110. The method further includes insulating the lubricant in the supply conduit 108, from heat transferred, e.g., by conduction and/or radiation, through and around one or more of the interfaces 102, 104 connecting the supply conduit 108 to the engine, with engine buffer air from the bearing compartment 38. In this configuration, the buffer air flows through an insulating cavity defined between an interior surface of the drain conduit 106 and an exterior surface of the supply conduit 108.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A lubricant supply system for a bearing damper in an engine bearing compartment of a gas turbine engine, the bearing compartment rotatably supporting an engine component and including a drain system for purging excess lubricant, comprising:
a first interface;
a second interface;
a drain conduit fluidly coupled to the first interface and extending from the first interface to the second interface;
the drain conduit receiving fluid including excess lubricant and lubricant purging air from the first interface;
a supply conduit located within the drain conduit extending between the interfaces;
the supply conduit providing lubricant to the bearing damper; and
fluid in the drain conduit is capable of insulting fluid in the supply conduit from heat transferred through the interfaces.

2. The system of claim 1, wherein:
the component is a turbine section, which includes a high pressure turbine, the bearing compartment is located in the turbine section, and the drain system is a scupper drain system;
the first interface connects with the engine bearing compartment;
the second interface connects with a turbine intermediate case;
the drain conduit is a scupper drain conduit; and
the supply conduit is a bearing damper supply conduit.

3. The system of claim 1, including a joint where the second interface connects with the drain conduit, the joint comprises a piloted o-ring.

4. The system of claim 1, wherein the drain conduit has a fluid inlet at the first interface, which includes a plurality of drain openings.

5. A gas turbine engine comprising:
a bearing compartment rotatably supporting an engine component and including a bearing damper and a drain system for purging excess lubricant;
a lubricant supply system for providing lubricant to the bearing damper, comprising:
a first interface;
a second interface;
a drain conduit fluidly coupled to the first interface and extending from the first interface to the second interface;
the drain conduit receiving fluid, including excess lubricant and lubricant purging air, from the first interface;
a supply conduit located within the drain conduit, the supply conduit providing lubricant to the bearing damper; and
fluid in the drain conduit is capable of insulting fluid in the supply conduit from heat transferred through the interfaces.

6. The engine of claim 5, wherein:
the component is a turbine section, which includes a high pressure turbine, and the bearing compartment is located in the turbine section, and the drain system is a scupper drain system;
the first interface connects with the engine bearing compartment;
the second interface connects with a turbine intermediate case;
the drain conduit is a scupper drain conduit; and
the supply conduit is a bearing damper supply conduit.

7. The engine of claim 5, including a joint, where the second interface connects with the drain conduit, the joint comprises a piloted o-ring.

8. The engine of claim 5, wherein the drain conduit has a fluid inlet at the first interface, which includes a plurality of drain openings.

9. A method of supplying lubricant to a bearing damper of bearing compartment of a gas turbine engine, comprising:
fluidly coupling a drain conduit to the bearing compartment, wherein the drain conduit receives fluid, including excess bearing lubricant and lubricant purging air, flowing in a first direction, away from the bearing compartment;
fluidly coupling a supply conduit to the bearing damper, wherein the supply conduit is located within the drain conduit and supplies lubricant in a second direction to the bearing damper, the second direction flowing toward the bearing compartment; and
insulating the lubricant in the supply conduit from heat transferred through one or more interfaces connecting the supply conduit to the engine with the engine buffer air that flows through an insulating cavity defined between an interior surface of the drain conduit and an exterior surface of the supply conduit.

10. The method of claim 9, wherein the drain conduit is connected at a joint to a turbine intermediate case interface with a piloted o-ring.
